(19) United States
(12) Patent Application Publication
(10) Pub. No.: US 2001/0036623 A1
(43) Pub. Date: Nov. 1, 2001

(54) Customized, interactive audio-visual media

(76) Inventor: Richard A. Johnson, Dannville, CA (US)

Correspondence Address: RICHARD A. JOHNSON, 1096 LEHIGH VALLEY CIRCLE, DANVILLE, CA, 94526, US

(21) Appl. No.: 09/817,295

(22) Filed: Mar. 27, 2001

Related U.S. Application Data
(60) Provisional application No. 60/193,330, filed on Mar. 30, 2000.

(51) Int. Cl. G09B 3/00

(52) U.S. Cl. 434/350

(57) ABSTRACT

A process is disclosed to construct an audio-visual program in real-time, which is customized to each individual's specific needs. The process is applicable to many types of electronically recorded materials, whether produced for training purposes, entertainment, or other use. The system can be packaged and delivered in products via local media, such as a compact computer disk (CD-ROM) or through a telecommunications network, such as an Intranet or Internet Web site. The system's components include special needs assessment materials, subject matter selection logic and control software, and a library of appropriate, recorded audio-visual snip-its (segments), from which the customized content is constructed.

### CROSS-REFERENCE TO RELATED APPLICATIONS, IF ANY

This application claims the benefit under 35 U.S.C. §119(e) of co-pending provisional application Serial No. 60/193,330, filed Mar. 30, 2000. Application Serial No. 60/193,330 is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention.

The present invention is a system process that utilizes a special user assessment tools, combined with software programs and recorded audio-visual information to produce media products that are customized in real-time, for each individual user. Applications for the process include real-time interactive training, a variety of assistance products, electronic games, and other, similar recorded materials.

The implementation of the system will allow mass distribution of audio-visual materials for a variety of purposes, in the form of either a compact computer disk (CD-ROM) or similar digital information storage devices, and over the Internet, that are customized to every user's individual needs.

2. Background Information.

Technology is available now that provides innovative computer based training (CBT) methods by using interactive “movies” of video and audio information stored on CD-ROM and/or available online over the Internet from a Web site that provides such interactive services. Some of these products use “decision tree” logic, which plays the next sequence of events based upon a current decision that is made by the user, on an interactive basis. In this manner, consequences of certain behavior or decisions can be illustrated and thus the learning experience is enhanced.

One major issue with this type of interactive service is that mass distribution of media products normally requires that the material be produced for general appeal. Thus, the presentation of the subject matter is usually geared to the least knowledgeable user/person who is to be trained or familiarized with the recorded subject matter.

Unfortunately, efficiency is compromised in the products, because the subject matter must be written and produced so that it is applicable to a wide range of users. For example, each person has his/her own level of current familiarity with the subject matter; each person has unique issues of training or communication that must be dealt with individually to efficiently absorb the subject matter; and each person has his/her own learning pace and attention span. Applicant has devised a system, which greatly improves the effectiveness and efficiency of electronic-based, mass-distributed audio-visual products, such as training materials, electronic games and many others.

### SUMMARY OF THE INVENTION

The invention is a process and set of tools that first determine each individual user's specific needs via an assessment questionnaire pertaining to the recorded subject matter. The assessment tools are devised especially for measuring the characteristics of the individual (user), which are known to influence how the material ought to be presented for maximum benefit. Then, in real-time, through software logic, the process constructs a customized, interactive audio-visual product that addresses each individual's needs as effectively and efficiently as possible.

Thus, the system uses intelligent testing methods to determine the relevant and pertinent characteristics of the user, as applied to the subject matter. Then, the associated software program immediately examines and validates the results (output) of the testing process and constructs (selects) a logical, sequential series of electronic, digital files called “snip-its”. Snip-its are portions or subsets of the audio-visual subject matter that when played or applied in the proper sequence, collectively form a customized product for the individual. Each snip-its is a stored, electronic file that contains only a limited, designed segment of the overall subject matter. Ideally, a snip-it consists of the smallest subdivision of the overall interactive subject matter that can be coherent when it is properly placed in a series of other snip-its to create a presentation of the overall subject matter. Recording of the snip-its is normally planned in advance with the knowledge that each snip-it will be used as a building block of the presentation. However, snip-its may also be created “after-the-fact”, that is, after the entire audio-visual recording is complete. This is accomplished by logically breaking down the recorded audio-visual into segments that may be later reconstructed in an organized fashion to form meaningful patterns.

Then, each resulting snip-it is separated and stored as a unique file. Alternately, each snip-it may be stored in a form that can be logically extracted as a uniquely identifiable portion, so that it can be electronically “arranged” (played) in any sequence that it is needed for a particular individual, or can be left out entirely, if it is not applicable.

### BRIEF DESCRIPTION OF THE DRAWING

FIG. 1 is a schematic flow chart of the method of the present invention.

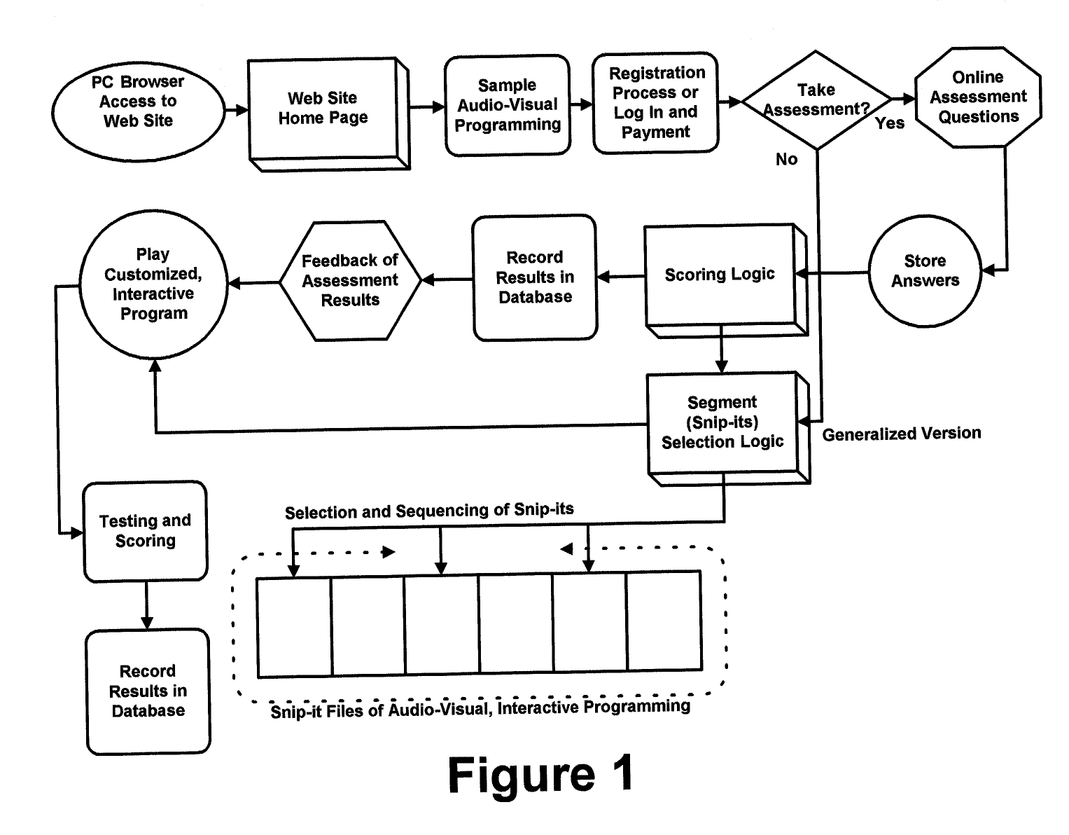

### DESCRIPTION OF THE PREFERRED EMBODIMENTS

The system of the present invention applies to products conveyed on a storage medium, such as a CD-ROM, for use with an individual computer and/or for products or services provided over an Internet Web site, Intranet, or similar networked facility. The user gains access to the audio-visual product from a computer, by either inserting the CD-ROM into a local drive or by wireless or wired telecommunications connection to a server that provides access to the product, that is, a Web site or a network server. A system module assesses the individual user's specific needs, skill level, his/her understanding of the environment, and other factors that are pertinent to the use of the interactive product, and then constructs and presents the appropriate materials to maximize the value intended by the product. Following is a typical sequence of how the process would flow, using the example of access over an Internet connection for a training program that deals with education about the issues of gambling problems.

### Registration or Log In and Payment

The user directs his/her browser program from a remote personal computer or similar device to connect with the Web site that contains the said system components. Once connected, the prospective user can read about the training program provided and view a short sample of the training materials before deciding to take the online training course. When the user decides to proceed, the first screen provides for registration, which establishes an account and a unique identity. Payment for the training session may be made online at this point as well, via a credit card or electronic check. Records are kept of the user's results from any completed assessment and training activities, such as his/her answers and test scores. This information is used for follow-up training recommendations and for private reporting purposes.

### Online Assessment Questions

Each step of the learning process is explained. First, the user is informed that a brief series of questions must be answered in order to customize the training to him/her for maximum benefit. The user may choose not to complete the questions. If so, he/she would be presented a generalized, rather than customized, version of the interactive training material. If the user chooses to complete the assessment, he/she is next presented with a series of questions and information to respond to that constitutes an “assessment” of crucial factors, for example psychological, social, financial, and historical information, that are designed to determine whether the user currently has a gambling problem, is developing a gambling problem, and where/if the user is at risk of developing problems related to gambling. The questions are based upon validated studies and the most current practices related to gambling problems. Questions are asked in areas that have been shown to be predictors of developing gambling problems, such as establishing a history of addictions.

### Processing Assessment Results

The user's answers to the assessment questions are stored in a database under the user's registered, private account. Immediately upon completion of the assessment questions, the scoring logic software program scores the results. The scoring logic generates the feedback to the user, a record of which is also stored in the database, and passes the results to a selection logic module. The selection logic module picks out the appropriate “snip-its” of recorded interactive audio-visual material, from the entire library available, that will form a customized training course for the user. Then, the program sets up and controls the proper sequence for the snip-its to be presented.

### Results Feedback

Written descriptions of the results of the assessment may be displayed, either before, after or during the audio-visual training session, depending upon the desired effect. In the presentation of the results and conclusions, the user is told what the assessment indicates as current problems, if any, based upon the responses he/she provided. Among other things, the user's areas of susceptibility to developing gambling problems are presented, and appropriate action is suggested.

### Playing The Audio-visual Program

The software selection logic sequences the appropriate snip-its that collectively constitute the optimal combination of materials needed to train the specific user. The objectives of the (example problem gambling) training are to provide maximum awareness of personal vulnerabilities to gambling problems, to help prevent development or exacerbation of problems, and to provide direction to rectify issues.

The audio-visual training snip-its are played to the user in the appropriate sequence, as controlled by the segment selection logic software. Only material that is germane to the user is selected from the available audio-visual files. In most instances, certain sequences are contained in the library of available snip-its that may have little or no benefit or relevance to a specific user. In these instances, the irrelevant portions will be omitted and only those sequences that have value to the user will be played, in a logical order.

During the playing of the customized “movie”, choices may be presented to the user at various decision points, based upon the factors or situation portrayed in the “movie”. The choices made by the user may be used to determine the next or following set of sequences, representing probable outcomes or occurrences based upon the previous decision(s). Correct or appropriate answers to situations are indications of appropriate behavior that will avoid development of gambling problems, or may indicate recognition of existing problems.

By playing the interactive movie, answering the questions, and making the decisions presented, the user completes a learning experience that fulfills the objectives. That is, the experience provides maximum awareness of personal vulnerabilities to gambling problems, helps prevent development or exacerbation of problems, and provides direction to rectify issues that may exist. Associated services are offered that provide referrals to professional help, and explain guidelines for safe gaming.

### Testing and Scoring

Self-test questions are included as a part of the audio-visual training. The test questions serve as a review of the material and indicate the degree of retention by the user. The user is provided instant feedback of the test results and correct answers are supplied as the test proceeds.

I claim:

1. A method for customizing a wide variety of audio-visual programming, such as digitally recorded training programs, and entertainment, to each individual user's needs. The customization is done instantaneously as a result of a designed assessment of need, so that the user may proceed to play the programming without delay. The method is comprised of the following steps;
(a) assessing the specific needs of each user by a designed questionnaire that may be administered via the global telecommunications network or by local, stored electronic media;
(b) storing the assessment results in a database and scoring the results via software logic so as to ascertain the exact material that is appropriate to present to the individual;
(c) displaying written results of the assessment to the user;
(d) selecting and sequencing the appropriate segments of recorded materials from an available library of segments, through software logic;
(e) playing the resulting customized, interactive audio-visual program in the correct sequence;
(f) testing and scoring the interactive results of the use of the customized audio-visual material by the individual.
